(19) United States
(12) Patent Application Publication
(10) Pub. No.: US 2007/0098562 A1
(43) Pub. Date: May 3, 2007

(54) Blade

(75) Inventor: David J. Tudor, Derby (GB)

Correspondence Address: OLIFF & BERRIDGE, PLC, P.O. BOX 19928, ALEXANDRIA, VA, 22320, US

(73) Assignee: Rolls-Royce plc, London (GB)

(21) Appl. No.: 11/447,925

(22) Filed: Jun. 7, 2006

(30) Foreign Application Priority Data
Jun. 30, 2005 (GB) 0513377.2

(51) Int. Cl. B64C 11/16

(52) U.S. Cl. 416/236 R

(57) ABSTRACT

A fan blade (26)comprises a root portion (36) and an aerofoil portion (38). The aerofoil portion (38) has a leading edge (44), a trailing edge (46) and a tip (48) remote from the root portion (36). A concave pressure surface (50) extends from the leading edge (44) to the trailing edge (46) and a convex suction surface (52) extends from the leading edge (44) to the trailing edge (46). A groove (54) is provided in the tip (48) of the aerofoil portion (38)between the leading edge (44) and the trailing edge (46) of the aerofoil portion (38). The groove (54) in the tip (48) of the aerofoil portion (38)is spaced from the leading edge (44) and is spaced from the trailing edge (46). The groove (54) in the tip (48) of the aerofoil portion (38) allows a natural flow of fluid from the concave pressure surface (50) to the convex suction surface (52) of the aerofoil portion (38). This reduces vibrations of the fan blade (26).

The present invention relates to a blade, and in particular to a fan blade for a turbofan gas turbine engine.

Small tip chord turbofan clapper less fan blades may suffer from vibration where altitude aerodynamic forces lead to excitation of a fan blades natural modes of vibration, e.g. second flap mode, away from coincidence with the harmonics of a fan blades rotational speed, i.e. a non integral vibration. At high fan blade rotational speeds, forward propagating pressure waves normal to passage shock waves are formed in the passages defined circumferentially between the radially outer tips of adjacent fan blades and bounded by the fan casing which provides useful compression of the air flow. However, at altitudes greater than about 40000 ft, 12200 m, and over specific speed ranges, greater than about 1500 fts⁻¹, 457 ms⁻¹ and fan blades having a tip chord length of less than 300 mm, excitation of natural modes of vibration of the fan blades due to unsteady motion of the shock waves has led to divergent fan blade vibration.

These unsteady pressure waves from the normal to the passage shock propagate in an upstream direction in the passages between the tips of the fan blades in the high Mach No. flow. These unsteady pressure waves are of concern where the pressure waves have short wavelengths approximating to 0.5, 1.5, 2.5 times the chord wise length of the passage between the tips of adjacent fan blades, the passage length extends from the leading edge to the trailing edge of the fan blades. These unsteady pressure waves may provide anti-phase excitation of leading edge motion of adjacent fan blades. If there is a coincidence of the mode shape, e.g. significant leading edge motion of the fan blades within the second flap vibration mode shape, divergent blade vibration is produced, which reduces the life of the fan blades and increases the incidence of mechanical failure, e.g. cracking.

Accordingly the present invention seeks to provide a novel blade, which at least reduces the above problem.

Accordingly the present invention provides a blade comprising a root portion and an aerofoil portion, the aerofoil portion has a leading edge, a trailing edge and a tip remote from the root portion, a concave pressure surface extends from the leading edge to the trailing edge and a convex suction surface extends from the leading edge to the trailing edge, the tip of the aerofoil portion between the leading edge and the trailing edge of the aerofoil portion has a groove extending radially inwardly from the remainder of tip of the aerofoil portion and extending from the convex suction surface to the concave pressure surface, the groove in the tip of the aerofoil portion is spaced from the leading edge and is spaced from the trailing edge.

Preferably the groove in the tip of the aerofoil portion extends radially inwardly from the remainder of the tip of aerofoil portion in the range of 0.5% to 1.5% of the chord length of the tip of the aerofoil portion.

Preferably the groove in the tip of the aerofoil portion extends radially inwardly from the remainder of the tip of aerofoil portion by 1% of the chord length of the tip of the aerofoil portion.

Preferably the groove in the tip of the aerofoil portion extends radially inwardly from the remainder of the tip of the aerofoil portion by 3 mm.

Preferably the groove in the tip of the aerofoil portion extends from a position at about 40% of the chord length from the leading edge to a position at about 60% of the chord length from the leading edge.

Preferably the groove in the tip of the aerofoil portion extends from a position at about 45% of the chord length from the leading edge to a position at about 55% of the chord length from the leading edge.

Preferably the groove in the tip of the aerofoil portion extends chordally of the tip of aerofoil portion by 35 mm of the chord length of the tip of the aerofoil portion.

Preferably the centre of the groove is arranged at a position at about 50% of the chord length from the leading edge.

Preferably the blade is a fan blade.

Preferably the blade has a tip chord length of less than 300 mm.

The present invention will be more fully described by way of example with reference to the accompanying drawings in which:

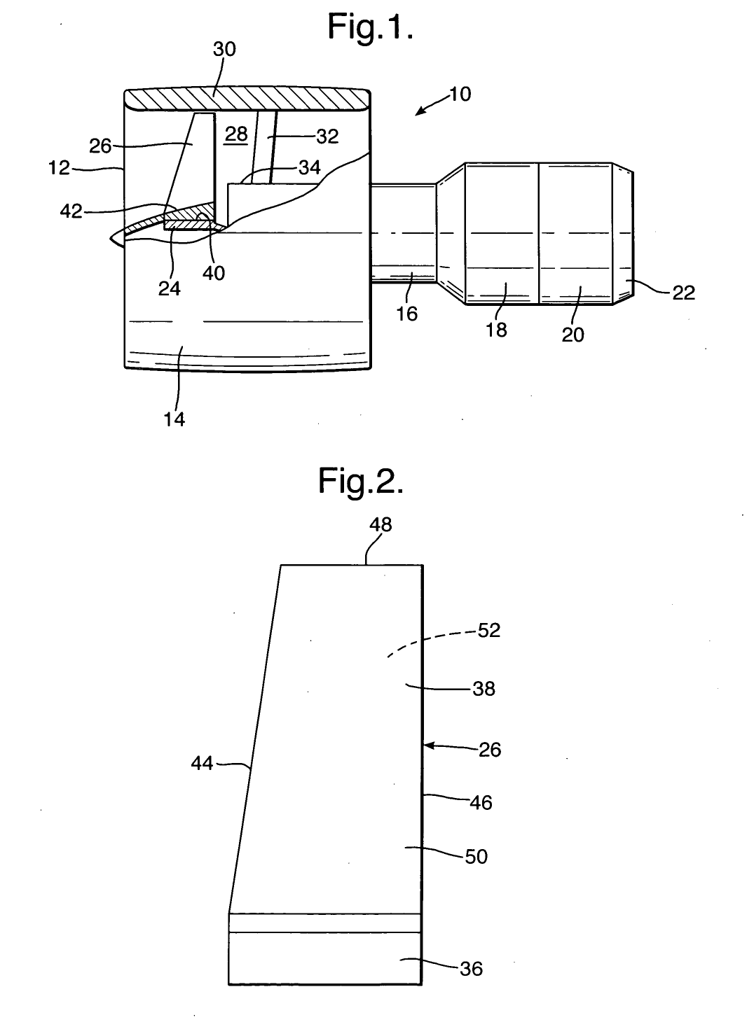

FIG. 1 shows a turbofan gas turbine engine having a fan blade according to the present invention.

FIG. 2 shows a fan blade according to the present invention.

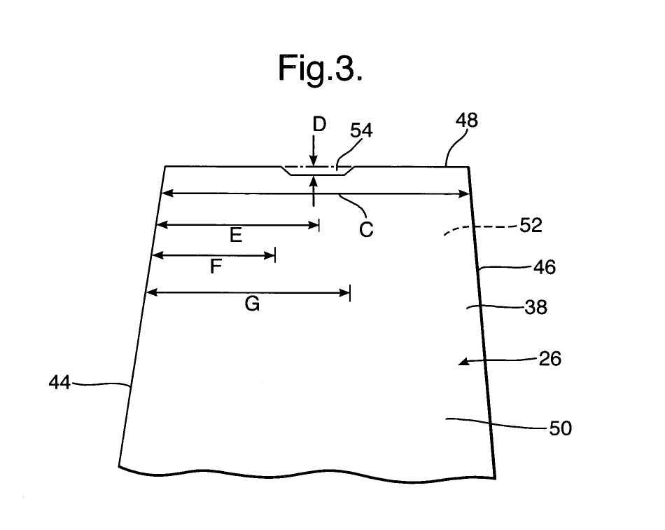

FIG. 3 shows an enlarged view of a tip of the fan blade shown in FIG. 2.

A turbofan gas turbine engine 10, as shown in FIG. 1, comprises in flow series an inlet 12, a fan section 14, a compressor section 16, a combustion section 18, a turbine section 20 and an exhaust 22. The fan section 14 comprises a fan rotor 24 carrying a plurality of circumferentially spaced radially outwardly extending fan blades 26. The fan blades 26 are arranged in a bypass duct 28 defined by a fan casing 30, which surrounds the fan rotor 24 and fan blades 26. The fan casing 30 is secured to a core engine casing 34 by a plurality of circumferentially spaced radially extending fan outlet guide vanes 32. The fan rotor 24 and fan blades 26 are arranged to be driven by a turbine (not shown) in the turbine section 20 via a shaft (not shown). The compressor section 16 comprises one or more compressors (not shown) arranged to be driven by one or more turbines (not shown) in the turbine section 20 via respective shafts (not shown).

A fan blade 26 according to the present invention is shown more clearly in FIGS. 2 and 3. The fan blade 26 comprises a root portion 36 and an aerofoil portion 38. The root portion 36 is arranged to locate in a slot 40 in the rim 42 of the fan rotor 24, and for example the root portion 36 may be dovetail shape, or firtree shape, in cross-section and hence the corresponding slot 40 in the rim 42 of the fan rotor 24 is the same shape. The aerofoil portion 38 has a leading edge 44, a trailing edge 46 and a tip 48 remote from the root portion 36 and the fan rotor 24. A concave pressure surface 50 extends from the leading edge 44 to the trailing edge 46 and a convex suction surface 52 extends from the leading edge 44 to the trailing edge 46.

A groove 54 is provided in the tip 48 of the aerofoil portion 38 between the leading edge 44 and the trailing edge 46. The groove 54 in the tip 48 of the aerofoil portion 38 is spaced from the leading edge 44 and the trailing edge 46. The groove 54 in the tip 48 of the aerofoil portion 38 extends radially inwardly by a radial depth D from the remainder of the tip 48 of aerofoil portion 38 and the radial depth D is in the range of 0.5% to 1.5% of the chord length C of the tip 48 of the aerofoil portion 38.

In particular the groove 54 in the tip 48 of the aerofoil portion 38 extends radially inwardly from the remainder of the tip 48 of aerofoil portion 38 by a radial depth D of 1% of the chord length C of the tip 48 of the aerofoil portion 38. The groove 54 in the tip 48 of the aerofoil portion 38 extends radially inwardly by a radial depth D from the remainder of the tip 48 of the aerofoil portion 38 of 3 mm.

The groove 54 in the tip 48 of the aerofoil portion 38 extends from a position F at about 40% of the chord length C from the leading edge 44 to a position G at about 60% of the chord length C from the leading edge 44. In particular the groove 54 in the tip 48 of the aerofoil portion 38 extends from a position F at about 45% of the chord length C from the leading edge 44 to a position G at about 55% of the chord length C from the leading edge 44.

The groove 54 in the tip 48 of the aerofoil portion 38 extends chordally of the tip 48 of aerofoil portion 38 by 35 mm of the chord length C of the tip 48 of the aerofoil portion 38.

Preferably the centre of the groove 54 is arranged a distance E, at a position at about 50% of the chord length C, from the leading edge 44.

The fan blade 26 has a tip chord length C of less than 300 mm.

The groove 54 in the tip 48 of the aerofoil portion 38 of the fan blade 26, provides a local over the tip 48 leakage path for working fluid, air, which disrupts the forward, upstream, propagating unsteady pressure wave. The groove 54 in the tip 48 of the aerofoil portion 38 of the fan blade 26 allows a natural flow of fluid, air, from the concave pressure surface 50 to the convex suction surface 52 of the aerofoil portion 38, which attenuates and disrupts the unsteady forward, upstream, propagating unsteady pressure waves. The dimension of the groove 54 in a chordal direction is arranged to exceed the predicted wavelength of the unsteady pressure wave. The radial depth of the groove 54 is arranged to be a minimum, while achieving useful attenuation without compromising other aerodynamic performance factors. The groove 54 is arranged within the tip 48 of the aerofoil portion 38 to suit a predicted peak of unsteady amplitude of the forward, upstream, propagating pressure wave and may for example be at the mid-chord position, or at other suitable positions, in the tip 48 of the aerofoil portion 38.

The groove 54 in the tip 48 of the aerofoil portion 38 of the fan blade 26 disrupts the unsteady pressure wave reinforcing the divergent non-integral fan blade 26 vibration at high speed and high altitude operation. This leads to increased life of the fan blade 26 and reduces the possibility of mechanical failure of the fan blade 26 under high altitude cruise conditions.

The present invention is applicable to clapperless fan blades which lead to excitation of other natural modes of vibration, e.g. first flap mode, third flap mode, first torsion mode, second torsion mode or combinations thereof or any of the first ten fundamental vibration modes. The present invention is applicable to metal fan blades and hybrid structured fan blades e.g. composite fan blades. In the case of some designs of hybrid structured fan blades there may be other natural modes of vibration that are not easy to describe using first flap mode, second flap mode, third flap mode, first torsion mode or second torsion mode because the complex structure of these hybrid structured fan blades may distort such mode shapes out of recognition.

I claim:

1. A blade comprising a root portion and an aerofoil portion, the aerofoil portion has a leading edge, a trailing edge and a tip remote from the root portion, a concave pressure surface extends from the leading edge to the trailing edge and a convex suction surface extends from the leading edge to the trailing edge, the tip of the aerofoil portion between the leading edge and the trailing edge of the aerofoil portion has a groove extending radially inwardly from the remainder of the tip of the aerofoil portion and extending from the convex suction surface to the concave pressure surface, the groove in the tip of the aerofoil portion is spaced from the leading edge and is spaced from the trailing edge.

2. A blade as claimed in claim 1 wherein the groove in the tip of the aerofoil portion extends radially inwardly from the remainder of the tip of aerofoil portion in the range of 0.5% to 1.5% of the chord length of the tip of the aerofoil portion.

3. A blade as claimed in claim 2 wherein the groove in the tip of the aerofoil portion extends radially inwardly from the remainder of the tip of aerofoil portion by 1% of the chord length of the tip of the aerofoil portion.

4. A blade as claimed in claim 1 wherein the groove in the tip of the aerofoil portion extends radially inwardly from the remainder of the tip of aerofoil portion by 3 mm.

5. A blade as claimed in claim 1 wherein the groove in the tip of the aerofoil portion extends from a position at about 40% of the chord length from the leading edge to a position at about 60% of the chord length from the leading edge.

6. A blade as claimed in claim 5 wherein the groove in the tip of the aerofoil portion extends from a position at about 45% of the chord length from the leading edge to a position at about 55% of the chord length from the leading edge.

7. A blade as claimed in claim 1 wherein the groove in tip of the aerofoil portion extends chordally of the tip of the aerofoil portion by 35 mm of the chord length of the tip of the aerofoil portion.

8. A blade as claimed in claim 1 wherein the centre of the groove is arranged at a position at about 50% of the chord length from the leading edge.

9. A blade as claimed in claim 1 wherein the blade is a fan blade.

10. A blade as claimed in claim 1 wherein the blade has a tip chord length of less than 300 mm.

11. A blade as claimed in claim 1 wherein the dimension of the groove in a chordal direction is greater than the wavelength of an unsteady pressure wave.
